(19) United States
(12) Patent Application Publication
(10) Pub. No.: US 2002/0111840 A1
(43) Pub. Date: Aug. 15, 2002

(54) Method and apparatus creation and performance of service engagement modeling

(76) Inventors: Edward P. Bagdonas, Newton, MA (US); Jonathan P. McClure, Beverly, MA (US); Michael T. Renzi, Rowley, MA (US); Ramesh Ramachandran, Burlington, VT (US)

Correspondence Address: Brett N. Dorny, Esq., Mintz, Levin, Cohn, Ferris,, Glovsky and Popeo, P.C., One Financial Center, Boston, MA, 02111, US

(21) Appl. No.: 09/784,520

(22) Filed: Feb. 15, 2001

(51) Int. Cl. G06F 17/60

(52) U.S. Cl. 705/7

(57) ABSTRACT

A system for assisted performance of repetitive functions within a service engagement provides platform for storage and execution of processes and corresponding data. The platform includes libraries for storage of application packages, assets and artifacts. Application packages, assets and artifacts from within the library can be associated with engagements to provide models of the engagement and perform functions necessary in the course of the engagement. The assets and artifacts can be repetitively used by various application packages and other assets in order to achieve the various objectives of those application packages.

### BACKGROUND OF THE INVENTION

1. Field of the Invention

The present invention relates to service engagements for the design, implementation, and monitoring of hardware and software configurations in order to meet specified requirements. More particularly, it relates to a computer-assisted process for performing appropriate functions in for a specified service engagement. Additionally, it relates to a system for creation and storage of functions and repurposed use of information and functions during a service engagement.

2. Discussion of the Related Art

Electronic commerce and marketing have developed into a burgeoning business. As many new and traditional companies attempt to enter the e-commerce world, they are faced in increasingly complex hardware and software systems for which they lack sufficient experience for implementation and maintenance. Furthermore, the e-commerce needs of companies vary significantly. Therefore, a one-size-fits all system is not appropriate for all companies and highly individualized approaches are required. There are also many different incompatibilities between hardware and software from various sources. Thus, a market has developed for consultants to assist in the selection, organization, creation, deployment and maintenance of e-commerce systems. The consultants' role is referred to as a service engagement. However, typically, these consultants approach each service engagement as a blank page—developing each system from scratch based upon a particular client's need. This approach ignores the similarities between engagements, such that work is duplicated with each engagement. It also complicates subsequent changes, modifications or expansions of a system once the system has been designed and implemented. Accordingly a need exists for a system which partially automates the engagement process and maintains information regarding an engagement for future maintenance and modifications.

The design and implementation of web-based, e-commerce/e-marketing systems involves familiarity with many tools and applications for analyzing, installing and configuring existing or new applications. Most web-based deployments differ in the complexity and variety of backend application layers, which may include application servers, recommendation engines, content servers, databases and content brokering services. Moreover, the scalability and performance requirements vary greatly with different business models. One business may require a highly scalable system that supports millions of hits per hour while another may never exceed 10,000 hits per hour or per day.

Nevertheless, the kinds of technical services required by customers deploying or trying to improve e-commerce systems vary only in degree. Most of these systems involve a common pattern of technical requirements. These patterns tend to repeat from one engagement to another. In observing these repeating patterns—configuring marketing databases, auditing the installation of third party applications, probing operating system configuration settings, collecting customer requirements, etc.—one thing is clear: these are time-consuming, tedious, and repetitive tasks. Capturing these similarities and differences between engagements, these common patterns, is part of what Engagement Modeling is about. Engagement Modeling offers a comprehensive, flexible and re-usable solution that dramatically increases the quality, efficiency and speed-to-market of implementations.

In today's web-oriented world, implementing a successful client solution is difficult. Professional service organizations face numerous challenges in identifying and meeting client needs. There are numerous products in the market today that provide core capabilities, a development methodology and offer configuration strategies designed to address some of the implementation problems. The fundamental weaknesses in the existing approaches include the failure to recognize the patterns in process and implementation, as well as the inability to automate those tasks. While it seems obvious to state that the needs of each client and each engagement are highly specific, it seems equally obvious that it is undesirable to approach each new implementation as if were the first one—constantly repeating and manually performing tasks done before.

Predictably, there are some patterns that manifest themselves in a consistent manner across all engagements. These observations suggest there is a market for utilizing a development methodology based on modeling engagements in order to re-use the collected engagement knowledge and information to improve the efficiency, speed-to-market, and repeatability of implementing each subsequent client solution.

### SUMMARY OF THE INVENTION

The present invention substantially overcomes the deficiencies of the prior art by providing a system for the assisted performance of repetitive functions within a service engagement. According to one aspect, the present invention includes a platform for storage and execution of processes and corresponding data. The platform includes libraries for storage of assets and artifacts. Assets, within the meaning of the present invention, are discrete processes. Assets may incorporate and access other assets. Artifacts include specific data relevant to an engagement, which are created and used by assets. Application packages, which are combinations of assets and related artifacts, are also stored in the library for use. In performing an engagement, the user selects and executes various application packages to perform functions appropriate for the specific engagement. New application packages can be added to extend the functionality of the system, as the need arises. The new application packages can also be utilized in other ongoing engagements or future engagement modeling.

According to another aspect of the invention, the platform accommodates a distributive system. Assets, artifacts and application packages are categorized according to a taxonomy used to locate the desired elements from anywhere within the distributed system. Application packages, or specific assets, can execute at different locations within the distributed system in order to achieve performance efficiencies. Additionally, the assets, artifacts and application packages may be represented by metadata within the system libraries, which identify locations within primary storage.

### BRIEF DESCRIPTION OF THE DRAWINGS

For a better understanding of the present invention, reference is made to the drawings which are incorporated herein by reference and in which:

FIG. 1 is a block diagram illustrating a logical view of an engagement modeling system according to an embodiment of the present invention.

FIG. 2 is a block diagram illustrating operation of an engagement modeling system according to an embodiment of the present invention.

FIG. 3 is a process flow diagram of an embodiment of an engagement modeling system.

FIG. 4 is a block diagram of an architecture for an engagement modeling system according to a first embodiment of the present invention.

FIG. 5 is a block diagram of another architecture for an engagement modeling system according to a second embodiment of the present invention.

FIG. 6 is a block diagram of a user interface according to an embodiment of the present invention.

FIG. 7 is a block diagram of a configuator agent according to an embodiment of the present invention.

FIG. 8 is a block diagram of an architecture for an engagement modeling system according to a third embodiment of the present invention.

FIG. 9 is a block diagram of an architecture for an application server according to an embodiment of the present invention.

FIG. 10 is a block diagram of a distributed processing environment according to an embodiment of the present invention.

FIG. 11 illustrates organization of assets according to an embodiment of the present invention.

FIGS. 12-17 illustrate a user interface for operation of an embodiment of the present invention.

### DETAILED DESCRIPTION OF PREFERRED EMBODIMENTS

The present invention provides an embodiment of a method and apparatus for engagement modeling. Engagement modeling using the present invention offers a comprehensive solution to the complex problems encountered in implementing e-commerce solutions on behalf of a client. Additionally, engagement modeling using the present invention simplifies modifications and revisions to an e-commerce solution. However, the present invention is not limited to e-commerce solutions. It can be used for any service engagement.

The objective of the present invention is to simplify the process for fulfilling a customer's requirements through a modeling process. The present invention stores and repeatedly utilizes information and processes with an engagement to achieve efficiencies and avoid duplicative effort and redundant data. An engagement model is constructed as a representation of the engagement throughout its life cycle. The construction records data relating to the engagement in a flexible manner so that it can be reviewed, modified, and analyzed to provide the proper processes to achieve the objectives of the engagement. The recorded data may be entered by users or created by applications or assets as part of the engagement modeling process. Furthermore, the data can be used by different applications to automate the processes for implementation or configuration of the engagement.

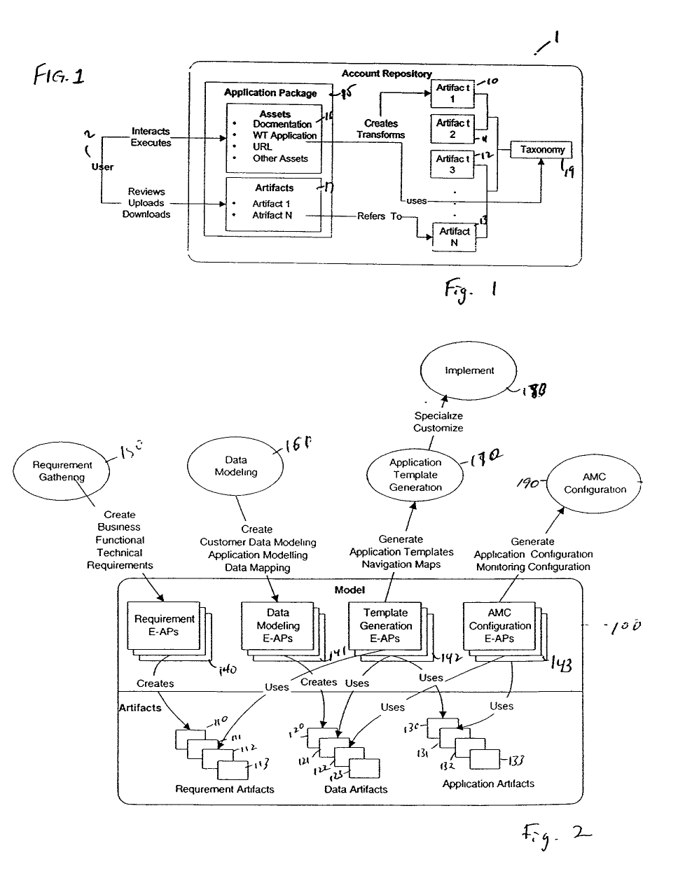

FIG. 1 illustrates, in block diagram form, a logical view of engagement modeling from the user's perspective. An engagement model 1 includes various components. The principal components are artifacts 10-13, application packages 15, and assets 16. Artifacts 10-13 are units of data relating to different parts of the engagement model 1. For example, artifacts may include requirements data, client infrastructure data, and model metadata. Assets 16 are independent functional processes. For example, an asset can include processes for collecting data or determining a desirable hardware or software configuration. Application packages 15 aggregate assets and artifacts relating to a specific problem, process step or solution to perform a process required by an engagement. An application package 15 also provides an interface with the user for viewing the artifacts 10-13 and corresponding assets 16 relative to the Application Package 15. In a sense, an application package may provide a view of a portion of an engagement model as it relates to the specific purpose of that application package.

Finally, the model 1 includes a taxonomy 19 for categorizing repurposeful data. Repurposeful data is data or artifacts which can be used by different assets to achieve different purposes. Also, assets are repurposeful data since they can be utilized by other assets. The taxonomy can create separate classification systems for artifacts, assets, application packages, and engagements, which could be considered distinct taxonomies. The objective of the taxonomy, or multiple taxonomies, is to provide users, applications and assets with the ability to locate necessary assets and artifacts. The taxonomy 19 permits the organization of stored items, particularly artifacts and assets, so that they can be easily located. Semantic descriptors, or metadata, provide meaning to the artifacts and facilitate application of the artifacts to specific purposes. The metadata relating to the artifacts 10-13, assets 16, and application packages 15 are stored in libraries, and classified according to the taxomony. The items themselves are stored in primary storage locations. The metadata is used to select items and access them within the primary storage locations. Reuse of artifacts for different purposes is achieved through specific assets. Of course, not all assets use artifacts. Some assets may be passive, such as database schemas, web pages, or documents. Others assets are active, such as applications or programs. In either case, the assets may reference and use artifacts for various purposes relating to the specific assets. The assets rely upon the taxonomy and semantic descriptors to ensure operability. Furthermore, the assets, in part, are based upon previously stored packaged solutions. These stored packaged solutions permit the reuse of assets and solutions in similar situations, as well as reuse of data for a specific engagement. The ability to reuse assets and data creates an automated system which improves performance and enhances customization within defined frameworks.

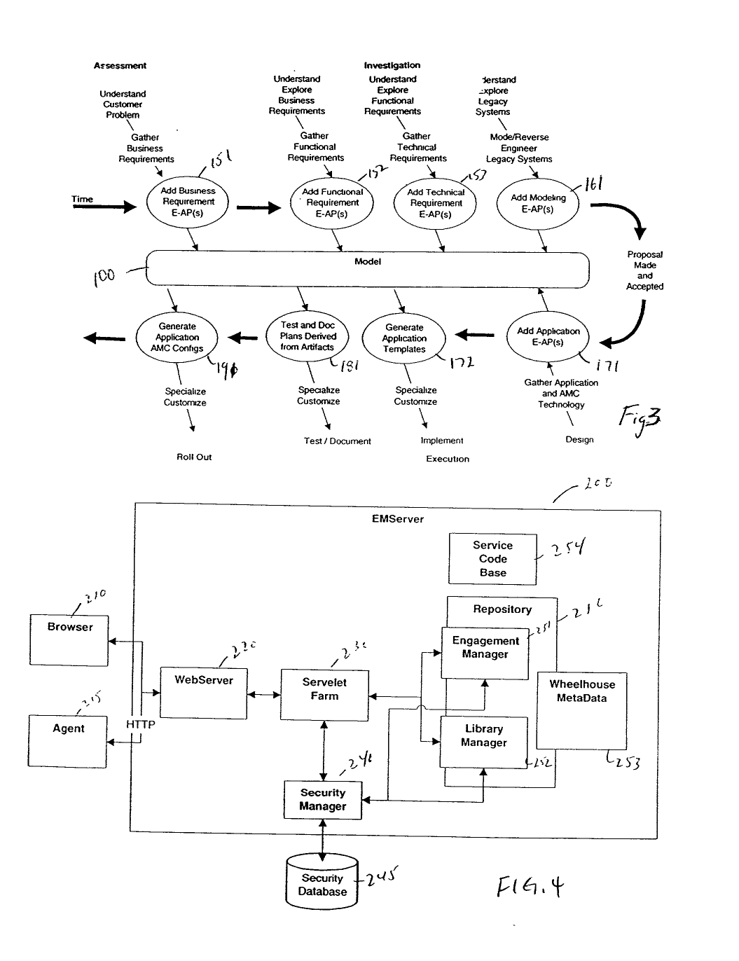

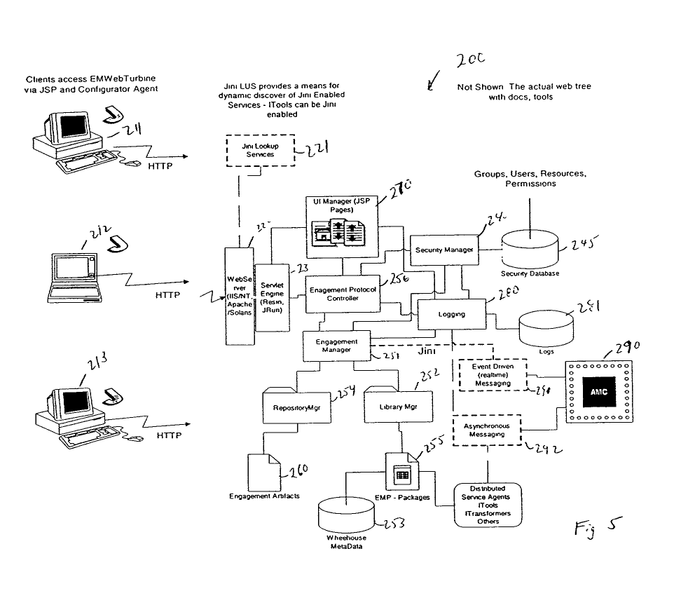

FIG. 2 illustrates the operation of an engagement model 100, including different application packages 15 for creation, use and modification of artifacts 10-13. FIG. 2 is merely illustrative of a general engagement model. The present invention provides a platform for the creation and use of engagement models and a framework for organizing and using information and processes. It is not limited to the specific application packages or types of application packages illustrated in FIG. 2. As discussed above, the engagement model 100 contains multiple application packages 140-143 and artifacts 110-113, 120-123, 130-133. In FIG. 2, the tasks 150, 160, 170, 180, 190 performed by the system user are illustrated outside the engagement model 100. FIG. 2 can be understood in conjunction with FIG. 3 which illustrates a process flow for model creation and use. In order to create and perform an engagement model, the user selects and executes specific application packages based upon the objectives of the engagement. As a first task 150, the user gathers and inputs requirements data. The user interfaces with the model 100 through specific application packages 140 for obtaining requirements data. The requirements application packages 140 create artifacts 110-113 relating to the requirements. The creation of requirements artifacts 110-113 may be an iterative process as illustrated in FIG. 3, including separately gathering and inputting business requirements 151, functional requirements 152 and technical requirements 153. The requirements application packages 140 provide a framework for collection of the necessary data. Different assets may be executed based upon the data which is entered. The user can review the application packages within a library to select the ones relevant to the particular engagement being created. Furthermore, the specific application package 140 used for the functional requirements task 152 may depend upon the data which has been gathered in the business requirements task 151. Similarly, the technical requirements task 153, and corresponding application package 140 may depend upon all of the data gathered or generated to that point.

Once the requirements artifacts 110-113 are created, the next task is data modeling 160. The data modeling task 160 may determine a proposal for software and hardware to meet the requirements. The data modeling task will determine the applications and configurations applicable to a solution based upon the customer requirements. This task can be performed by the user of the system, semi-automated or automated based upon common criteria in the customer requirements. The data modeling task 160 creates data artifacts in the model.

Following the data modeling task 160, a proposal 165 is created for the customer. The conceptual model is complete and can be explained to the customer. If the customer accepts the proposal 167, the modeling process continues to implement the conceptual design.

The first step for implementation is generation of application templates 170. Applications are generated using application packages 142. These packages, which are selected from a library, represent different applications. The application application packages 120-123 may be generally available third party applications, such as database modeling tools, as long as the data is structured. The application packages 142 create and use application artifacts 130-133 in development of the engagement model. Once the applications are selected and added to the model (step 171), application templates are generated. The templates are used for specialized customization of the client solution. Following the specialized customization, the engagement solution, as determined by the model is implemented. 180. Implementation includes configuration of the applications based upon the requirements artifacts 110-113 and data artifacts 120-123 in order to correspond to the particular customer's needs.

After implementation 180, the engagement model 100 can also be used for testing and monitoring. Configuration monitoring application packages 143 are selected from the library and form part of the engagement model. The specific application packages 143 depend in the specific implemented solution for the client. They may be selected by the user or automatically by the system based upon the stored artifacts. Monitoring application packages may include testing and documentation process 181 and general application monitoring configurations. Each of these types of application packages may need to be configured and/or customized for the particular environment. Since the engagement model includes the requirements artifacts, data artifacts and application artifacts, all of the information necessary for customization is present in the engagement model and can occur automatically or semi-automatically.

An embodiment of the hardware structures used to implement the present invention is illustrated in block diagram form in FIG. 4. As illustrated in FIG. 4, the invention may be implemented with an engagement modeling server 200. Users interact with the modeling system through typical server inputs, such as a browser 210 or agent 215. Additionally, an agent 215 may be an independent, autonomous process which intereacts with the modeling system. The server implementation allows for remote access, multiple users and wide-spread collaboration in engagement model development and use. Furthermore, the server implementation allows for expansion and flexibility. New assets and additional data can be added through a plug-able server architecture with a specialized protocol. The server structure also allows for distributed processing of the engagement model. Any active assets may be performed at the server, at the users computer, or at any other connected computer joined for operation of the engagement model.

As with all servers, the engagement modeling server 200 includes a webserver interface 220 for communications with the user browser 210 or agent 215. The webserver 220 is connected to a servelet farm 230 for executing code to perform the necessary functions of engagement modeling. The functions are stored as program code in an asset code base 254.

Access to the engagement modeling server 200 is controlled by a security manager 240. The security manager 240 may use ACL (access control list) information in a security database 245. Since the security manager is interconnected with the artifacts of the engagement model, open access control can be used in which different users may be able to access or change specific artifacts and/or execute specific assets.

The principal part of the engagement modeling server 200 is the repository 250. The repository 250 stores all of the assets and artifacts for both the library and engagement managers. An engagement manager 251 maintains and provides access to application packages (including the artifacts and assets) relating to an engagement model. The library manager 252 stores and provides access to the application package assets. When a specific asset is requested, the library manager will retrieve the appropriate asset and cause it to executed, either at the server or at any client or other appropriate location. Additionally, users of the system can review the possible assets available in the library for inclusion in any engagement model. The repository 250 also includes metadata 253. The metadata 253 is used to organize the artifacts and assets for ease of access. The taxonomy discussed above is implemented through the use of metadata.

A logging system (not shown), which could be part of the repository 250, can provide information as to the state of the engagement model and all actions which have been taken. The logging system records asset executions, repository accesses, and software actions, errors and messages. The logging system further allows for traceability. An audit trail of activities empowers requirements-driven development, ensures completeness of coverage for implementations, and aids in controlling the scope of the engagement modeling process.

FIG. 5 illustrates in block diagram form a more detailed view of the engagement modeling server 200. Again, the users 211-213 access the server 200 through a web interface. The server 200 may use one or more communications, server or distributed processing technologies, such as Java JSP, Java-based agents, and Jini technology. The server 200 can be easily integrated with standard APIs, schemas and enterprise solutions because it is built on a framework based on standard communication protocols (HTTP) and data protocols (XML Since the data is structured, such as in the form of machine readable XML schemas, value-added assets can be used to augment commercially available applications and can be easily incorporated in the system.

Since the engagement modeling process can be distributed, the sever 200 includes a mechanism for delivering agents (tools or assets) to remote clients for execution. The agents can be launched on the client machines to obtain data to be included in the artifacts, such as information on databases, e-commerce or other applications, operating system configurations, and hardware and software versions. Agents are delivered through HTTP. Additionally, an agent sometimes needs an artifact, or to supply an artifact, to the server 200. Since artifacts can have many forms, such as XML documents with structured information, SQL scripts, Java properties, and files, the system uses Content Object Stream to transfer information. While HTTP is still the transfer protocol, the transfer may occur with a communications component accessed by the agent at the client. Alternatively, agent to agent communications can be supported.

The webserver 220, servlet engine 230, and security manager 240 are the same as in FIG. 4, discussed above. As illustrated in FIG. 5, the webserver 220 may also be connected to a Jini lookup services control 221. Jini lookup services control 2221 provides a means for dynamic discovery of Jini enable services for execution of distributed services within the web-based system. The User Interface (UI) Manager 270 is application logic that manages the request/response interactions from the browser based interfaces. The UI Manager 270 handles redirection to appropriate JSP pages for login, security, user administration, and engagement operation and control. The engagement manager 256 provides the core management of the engagement model.

The engagement manager 256 brokers the access to engagement model data, including fetching artifacts from the repository 254, fetching application packages from the library 252, and storing artifacts and application packages. The engagement manager 256 may also cache recently used data (artifacts and application packages) in separate caches for each engagement for more rapid access to engagement data. Data about a particular engagement is stored and dynamically maintained in a single XML schema. This schema provides a unified view of the engagement and ties together both the structured and unstructured data along with an audited history. The schema functions as an index to the structured activities or tasks performed for an engagement. The schema is designed to accommodate external schema by means of external reference elements in order to include different types of data entities within an engagement.

The engagement manager 256 accesses the repository 260 through the repository manager 254 to retrieve artifacts. The repository manager 254 provides a consistent API for accessing artifacts which may be XML documents scripts, instructions, database schema, etc. Since the repository manager 254 is independent of the underlying storage engine or medium, different types of storage mechanisms can be used, such as an ordinary file system or database. The repository manager 254 maintains an XML-based schema that serves as a map or physical index to the contents of the repository. Similarly, library manager 252 maintains an index and provides access to assets in the library 255. The engagement manager 256 can utilize the information in the repository manager 254 and library manager 252 to access the artifacts and assets as necessary. Alternatively, the repository manager 254 and library manager 252 may act as conduits to the stored artifacts and assets.

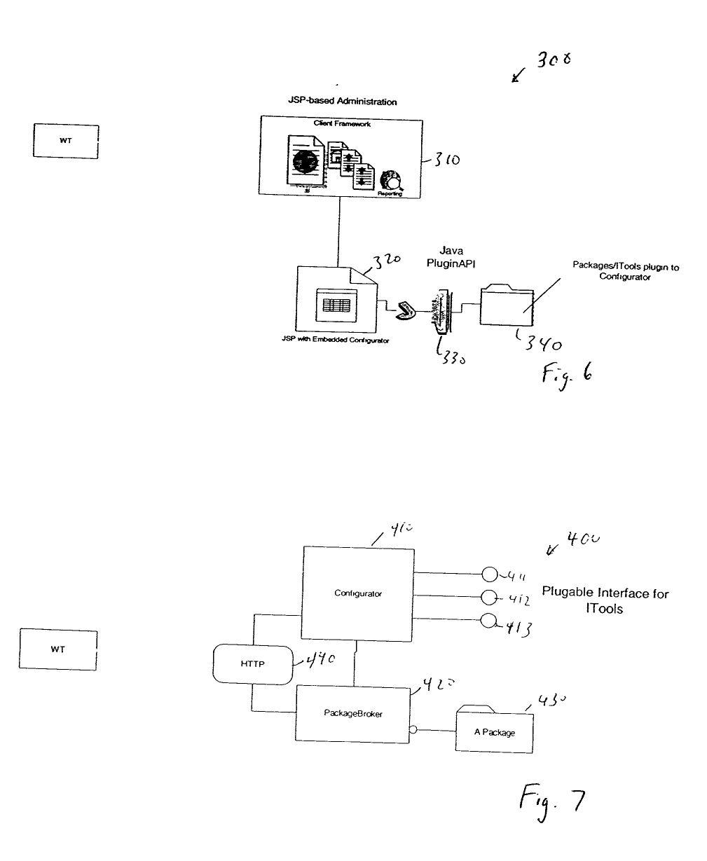

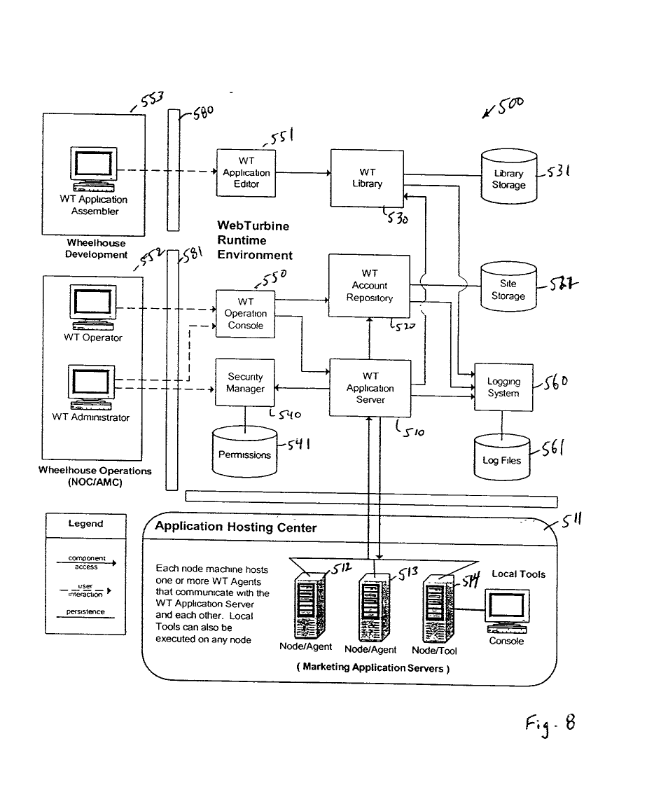

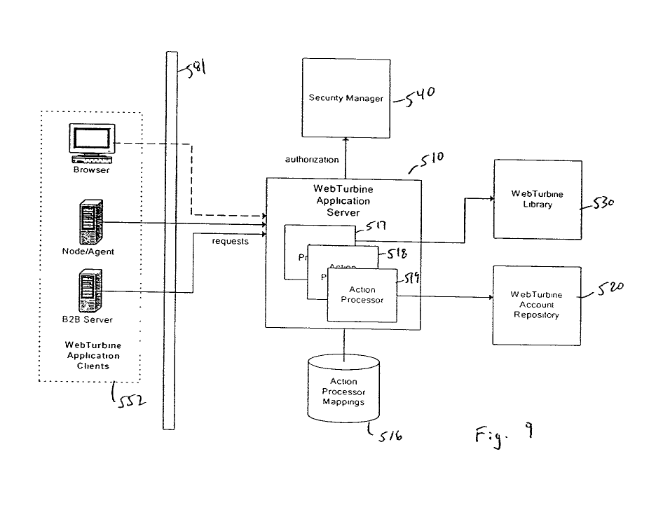

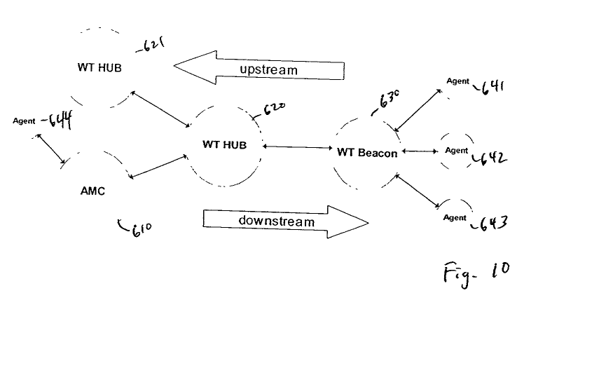

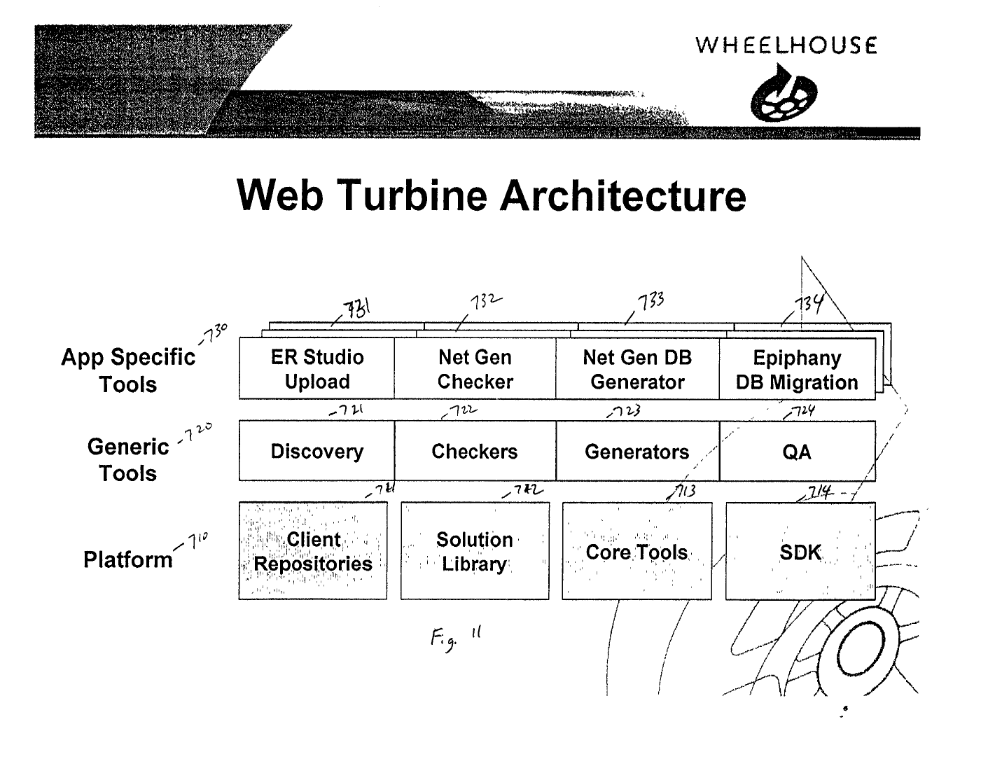

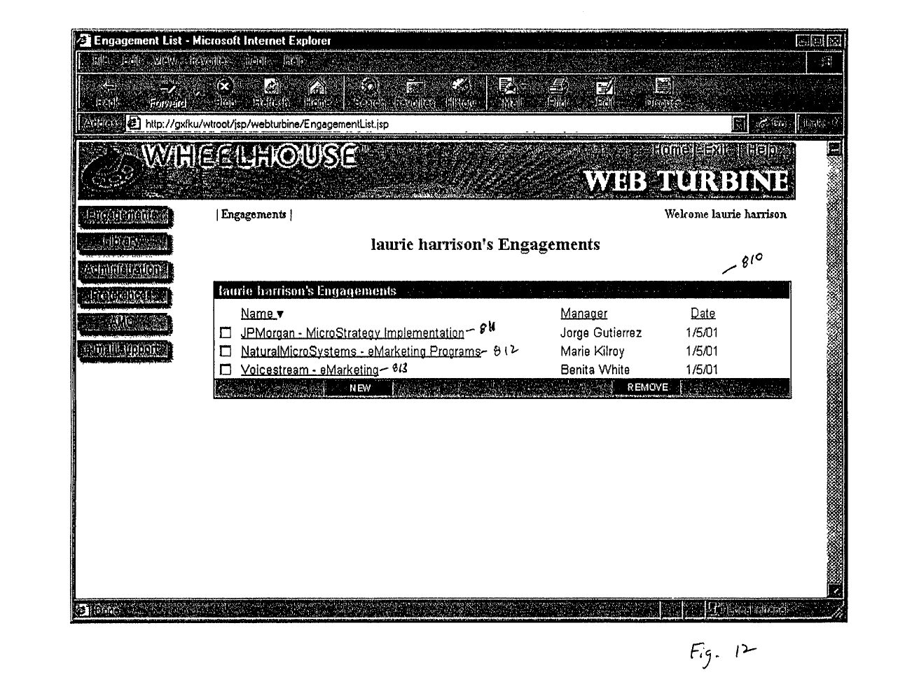

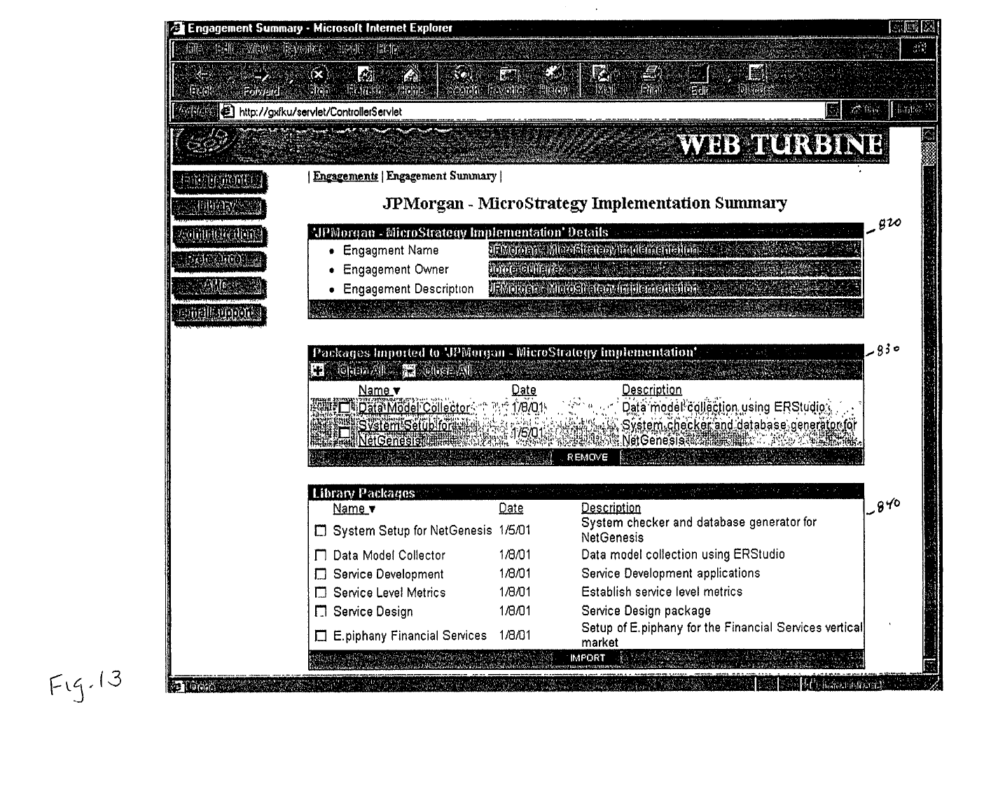

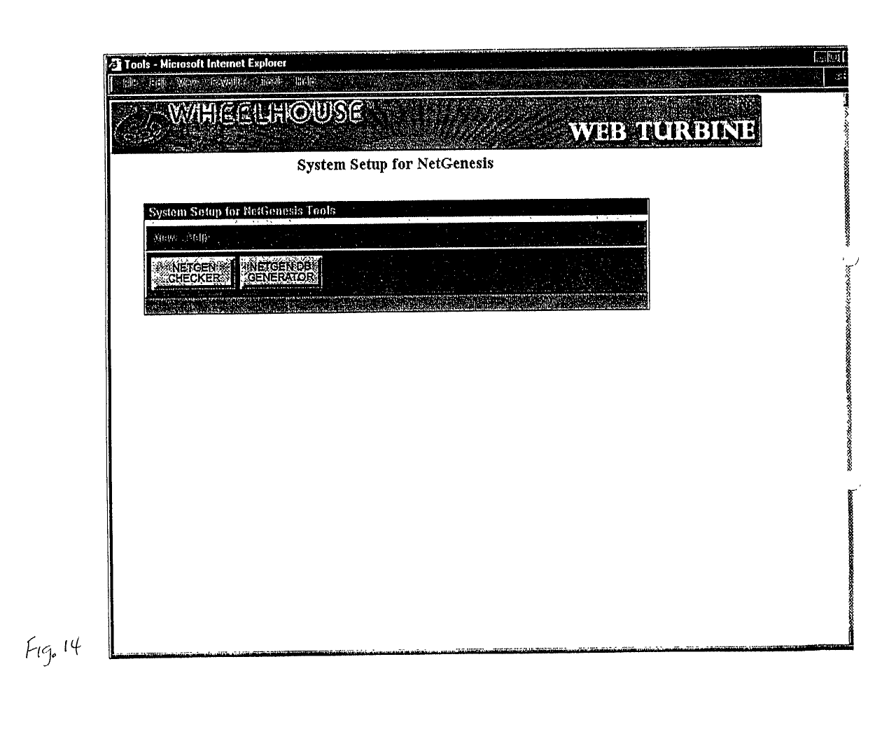

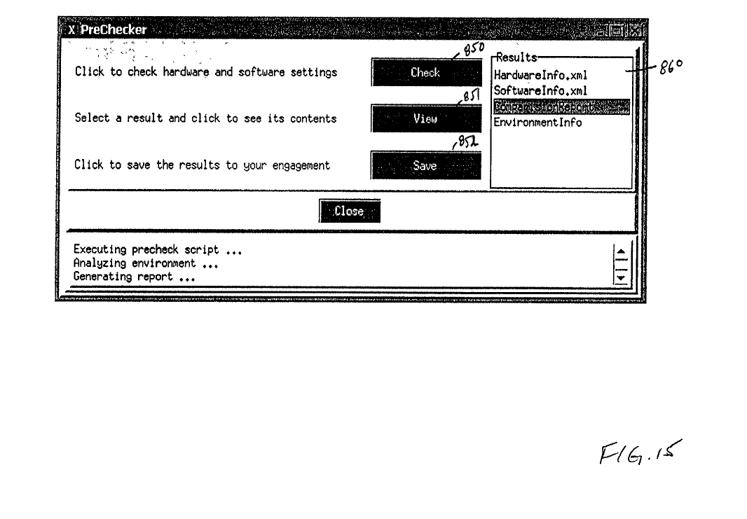

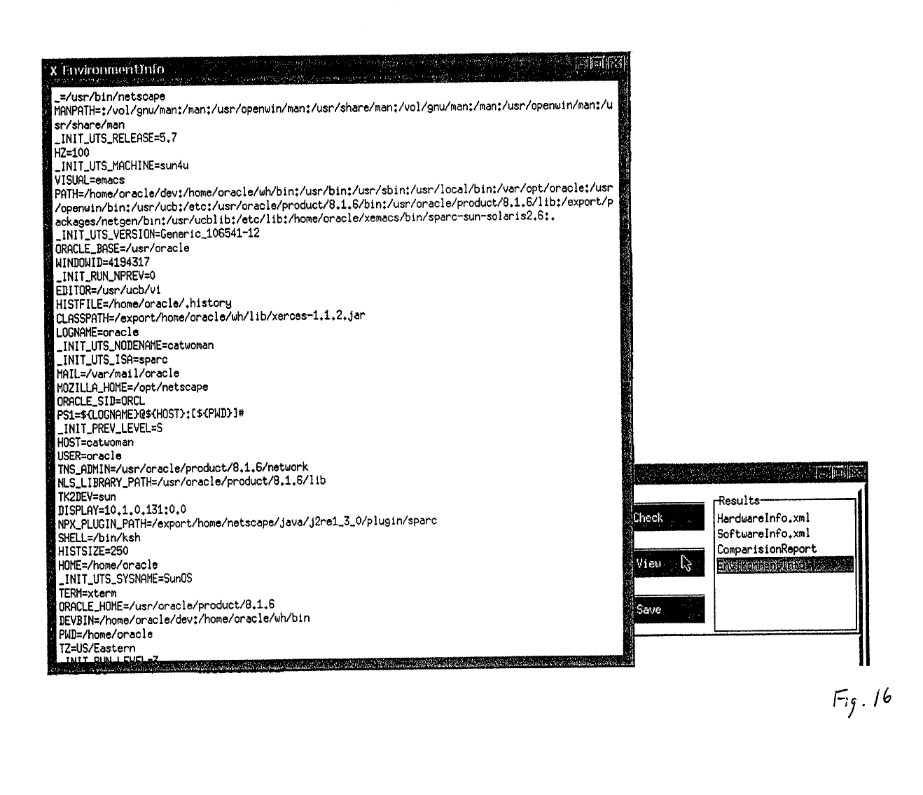

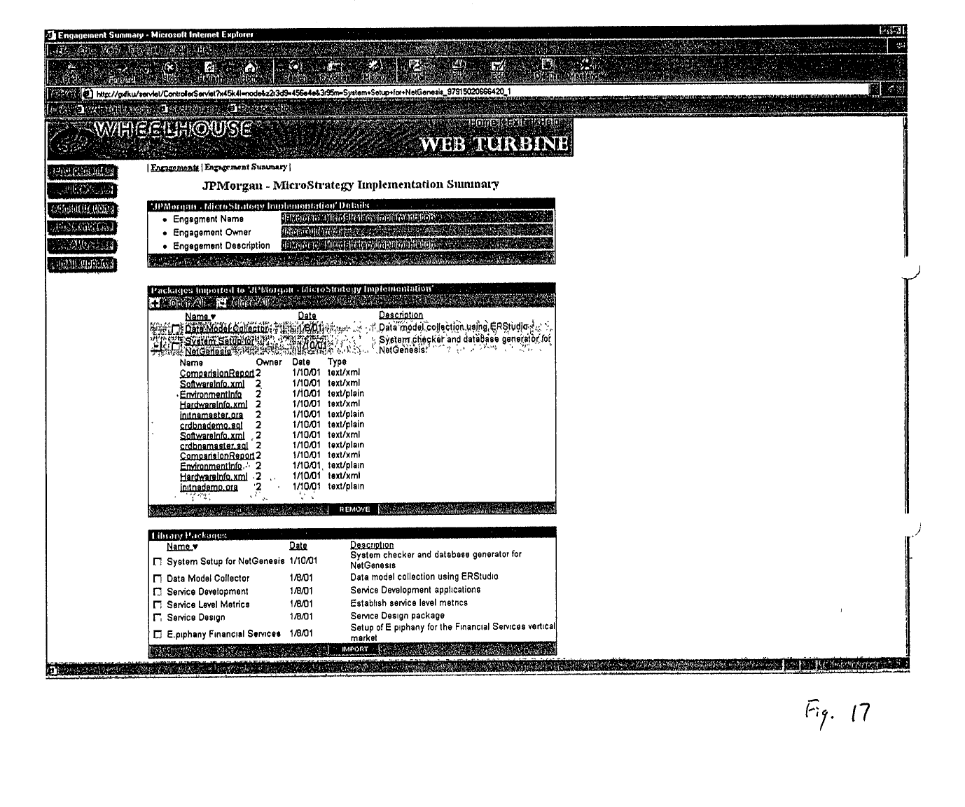

As noted above, users access the engagement modeling system through a web-based connection. In order to accommodate the features of the engagement modeling system, the client machine needs to have a specialized framework. From a user standpoint, the framework is divided into two parts, a JSP UI and Configuator agent, which are illustrated in FIGS. 6 and 7 respectively. FIG. 6 illustrates in block diagram form the components of the JSP UI 300. JSP pages are employed to bridge the interaction between the client usability and server-specific functionality.

The JSP interface 300 is primarily comprised of JSP pages 320 managed by the UI controller to pro provide administration and maintenance facilities and functionality. The JSP pages may have authorization privileges for users, groups and resources. The JSP UI 300 also provides the user with the ability to create, edit and store packages in the library.

Some JSP pages include the configuator agent which allows users to execute specific tools or assets and commit some or all of the results tools to a particular engagement in the modeling system. The configuator agent 400, illustrated in FIG. 7, is a Java-based agent designed to run with special privileges based upon digital certificates, as configured via a Java Plug-In API. The configuator agent 400 functions as a storage source for aglets or tools. The privileges give the configuator agent the ability to perform probing, intrusive tasks on the client system which are required for engagement implementation and technical analysis. The configuator 410 connects via HTTP protocol 440 to the engagement server. It also includes plugable interfaces 411-413 for different tools that conform to the SKD (software development kit) programming model, and comply with known tool interfaces such as ITool and ItoolUI.

The configuator agent 400 also includes a package broker 420 connected to the configuator 410. The package broker 420 unravels a package schema and controls the interchange of its constituent tools and artifacts. The package broker 420 determines how to instantiate the assets of the user-defined packages and manage the runtime behavior of the tools in the package. The package is independent of a specific engagement and can be used across multiple engagements. The tools and artifacts in the package can be run by a remote agent and delivered to the client, may run within the configuator agent 400, or may interact with a server-side asset. The configuator 410 provides the interface with the agents for execution of appropriate tools and agents.

FIG. 8 illustrates an architecture for the present invention according to a third embodiment of the present invention. A engagement modeling system 500 generally includes an application server 510, account repository 520, and a library 530. Users 552, 553 interface with the engagement modeling system 500 through respective interfaces 550, 551. A security manager 540 coordinates logins and passwords for the users to prevent unauthorized execution of application packages and assets, and lost or corruption of artifacts. A logging system 560 records accesses to the application server 510, account repository 520, and library 530 as necessary for control purposes. The information collected by the logging system 560 is stored in log files 561. In the event of operational problems, the log files can be used to locate and correct errors.

FIG. 8 illustrates two types of users, engagement modelers 552 and application creators 553. Application creators access the engagement modeling system 500 through an application editor 551. Assets and application packages are developed using SDKs for building tools and resources, according to known processes and APIs. The application editor 551 is used to upload created assets to the library 530, and to define the metadata for the asset. Metadata for an asset may include an ID, a name, an application type (such as archive, tool, agent, document, configuration, application package, URL, static web page and dynamic web page), a MIME type, version number, purpose, dependencies, and location in storage. Although assets are referred to as being in the library 530, the code corresponding to the assets is actually referred to by the library 530 and stored on the server as a java archive (jar) file in library storage 531. The library 530 stores the metadata relating to an asset. When an asset is to be accessed, the metadata in the library 530 is used to retrieve the appropriate code for the asset from the library storage 531. Similarly, artifacts are stored in site storage 532 and accessed through metadata in the account repository 521. Once an asset has been placed in the library, it may be accessed by application packages or engagement modelers. Engagement modeler 552 access the engagement modeling system 500 through an operation console 550, which is the server-user interface. The operation console 550 receives requests from the engagement modeler 552 and requests performance of appropriate application packages from the application server 510 or accesses artifacts in the account repository 520.

The application server 510 communicates with an application hosting center 511 comprised of multiple servers and/or processors 512, 513, 514. When an application is to be executed, it is retrieved, including all of the requested assets, from the library 530 by the application server 510 and executed on one or more servers or processors in the application hosting center. During execution of an application package, the application server 510 accesses the artifacts from the account repository 520, as necessary. FIG. 9 illustrates an embodiment of an application server 510. The application server 510 delegates all requests for assets to internal components called action processors 517, 518, 519. Each action processor 517, 518, 519 is responsible for delivering specific server functionality. The action processors may be plugable components. The use of additional action processors, with additional server functionality allows for extension of the application server. Parameters in the user requests are utilized in routing the request to the proper action processor. The mapping of parameters to action processors is stored in memory 516 accessed by the application server 510. Action processors may be used for accessing the library 530 and account repository 520, in addition to performing specific functions.

Although the above descriptions illustrate the elements of the engagement modeling system as a single entities, the present invention may be implemented in a distributed environment. FIG. 10 illustrates a distributed embodiment. The center of the distributed system is the Application Management Center (AMC) 610. Agents 644 connected to the AMC perform operations required by the assets. Also, additional hub servers 620, 621 are connected to the AMC 610 to provide an extensions of the application server. Beacon servers 630 connect to hub servers 620 to provide communication services and to mediate and manage events and services among local agents 641, 642, 643. The local agents 641, 642, 643 perform specific tasks associated with application performance. The use of local agents allows services to be provided anywhere in the distributed environment 600. The code for agents may be stored locally a beacon or client locations, or may be transmitted over the system depending upon the desired performance and storage requirements.

FIG. 11 illustrates the relationship between different types of assets in the building of application packages. Application packages are made up of different assets for performing various functions. Assets themselves may include other assets. In this manner, common processes can be used in various applications without the need for repeating the coding of these processes. FIG. 11 illustrates three levels of assets. Of course, FIG. 11 is merely illustrative of the asset structure and operation. At the lowest level are platform assets 710. These assets may provide the basic components for accessing artifacts. At the next level are generic tools 720. These assets perform processes which are general in nature, such as checking 722 current hardware and software at a location or generating 723 certain types of information. At the upper level are application specific tools 730. These assets process specific types of information to achieve the objectives of an application package. For example, the proper configuration of NetGenesis software depends upon the hardware configurations. An application package which determines the proper configuration needs to know information about the hardware and determine the appropriate parameters for the software configuration. For example, application package may include an asset for checking information 732 necessary for the NetGenesis configuration process. The NetGen checker 722, in turn, may utilize a generic checker for each part of the information needed. The information retrieved by the checker is stored as an artifact. The application package then utilizes a generator for NetGenesis. The NetGen generator 733 will utilize the generic generator 723 to create the necessary information, which is also stored as artifacts. The generators 733, 723 will also access the artifacts created by the checkers 732, 722 in creating the proper configuration. As necessary, the platform level assets may be accessed to perform requested functionality.

As noted above, an engagement modeler accesses the engagement modeling system through a user interface, which may be implemented as static or dynamic web pages as part of an application package. FIGS. 12-17 illustrate a graphical user interface (GUI) for access to the engagement modeling system. At a first screen (FIG. 12), the engagements 810 accessible by the user are displayed. Each engagement is named and other pertinent information regarding the engagement is displayed. Additionally, the user can create or delete engagements. Engagements are created by providing necessary information which is stored as artifacts in the account repository. Each user or account may have its own implementation of the engagement modeling system. However, in order to obtain efficiencies in the use of assets in the library, preferably, artifacts relating to multiple engagements and accounts are stored at a single location. The security system controls a user's access to specific engagements and/or information regarding such engagements. In order to proceed with an engagement, the user selects the name 811, 812, 813 of the engagement from the engagement list 810.

As illustrated in FIG. 13, when an engagement is selected, specific information relating to the engagement is displayed. As illustrated in FIG. 13, general information 820 regarding the engagement, such as the name, owner and description, may be displayed. The user may access this information to correct, add or modify it. Also, the application packages 830 relating to the engagement are displayed. These application packages may have or may not have been performed. Also, FIG. 13 illustrates a display of the application packages in the library 840 which are authorized for the engagement by the security manager. The user may select any of those application packages to be included in the current engagement. Based upon the objectives of the engagement, the user selects appropriate application packages from the library display 840 and imports them into the engagement 830. Importing application packages means that the metadata corresponding to those packages are associated with the engagement.

To execute an application package, the user selects the package from the display. Selection of an application package can retrieve a listing of assets corresponding to that application package, as illustrated in FIG. 14. For example, the “System Setup for NetGenesis” application package includes two tools, NetGen Checker and NetGen DB Generator. The user selects each of these tools in the appropriate order. The tools may provide additional displays (FIG. 15) and possible selection of assets. As illustrated in FIG. 15, additional assets can be used to check hardware and software settings 850, view specific results 851, and save the results 852. Results 860 are specific artifacts stored in the account repository. The assets can create, retrieve, or manipulate those artifacts. FIG. 16 illustrates the view asset displaying the contents of the EnvironmentInfo artifact. As discussed above, the artifact has the form of structured data. Once assets in an application package have been executed, the artifacts relating to that application package can be displayed in the engagement information screen as illustrated in FIG. 17.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only. It is not intended as limiting. The invention's limit is defined only in the following claims and the equivalence thereto.

We claim:

1. An engagement modeling system comprising:
a repository for storing a plurality of artifacts corresponding to an engagement;
a library having a plurality of assets, wherein said assets are processes which utilize at least one of said plurality of artifacts for use in an engagement; and
means for selecting at least one asset from said library of assets and for executing said at least one asset.

2. The engagement modeling system of claim 1, wherein said means for selecting includes an application server which receives a user request, retrieves assets corresponding to said user request from said library, and executes said assets.

3. The engagement modeling system of claim 2, wherein said application server further retrieves artifacts from said repository in connection with execution of said assets.

4. The engagement modeling system of claim 1, said library includes:
asset storage containing said assets; and
metadata storage containing metadata corresponding to and identifying each asset in said asset storage.

5. The engagement modeling system of claim 1, wherein said assets include at least one application package which references a plurality of assets in said library for execution.

6. The engagement modeling system of claim 1, wherein said means for selecting includes a plurality of computers jointly operating in a distributed computing environment.

7. The engagement modeling system of claim 1, further comprising an asset editor for creating and adding assets to the library.

8. A method for modeling service engagements comprising the steps of:
storing a plurality of assets in a library, wherein said assets are processes which utilize at least one of said plurality of artifacts for use in an engagement;
selecting at least one asset from said library of assets; and
executing said at least one asset

9. The method of claim 8 further comprising the step of:
storing at least one artifact created during execution of said at least one asset in a respository.

10. The method of claim 8 further comprising the step of:
accessing a repository of artifacts for use during execution of said at least one asset.

11. The method of claim 10, further comprising the steps of:
executing at least a second asset which accesses; and
accessing an artifact in said repository which was accessed during execution of said ate least one asset, for use during execution of said at least a second asset.

12. The method of claim 8, wherein selecting step includes the steps of:
receiving a user request;
retrieving at least one asset from said library corresponding to said user request; and
executing said at least one asset.

13. The method of claim 8, wherein said at least one asset is an application package which references at least one other asset stored in said library, and wherein said executing step includes the steps of:
executing said application package;
retrieving said at least one other asset from said library in response to execution of said application package; and
executing said at least one other asset.
